(19) United States
(12) Patent Application Publication
(10) Pub. No.: US 2024/0157451 A1
(43) Pub. Date: May 16, 2024

(54) DEVICE FOR ENGRAVING A KEY

(71) Applicant: SILCA S.P.A., Vittorio Veneto (TV) (IT)

(72) Inventors: Gennaro Giovanni NIGRO, Mareno di Piave (TV) (IT); Giorgio PIGATTI, Cordignano (TV) (IT); Oreste DA RODDA, Revine Lago (TV) (IT); Fabrizio TONELLO, Fontanafredda (PN) (IT); Franco CATTAI, Vittorio Veneto (TV) (IT)

(73) Assignee: SILCA S.P.A., Vittorio Veneto (TV) (IT)

(21) Appl. No.: 17/772,977

(22) PCT Filed: Oct. 30, 2020
(86) PCT No.: PCT/IB2020/060204

§ 371 Date: Apr. 28, 2022

(30) Foreign Application Priority Data
Oct. 31, 2019 (IT) 102019000020208

(51) Int. Cl. B23C 3/35; B23C 1/08

(52) U.S. Cl. CPC B23C 3/35; B23C 1/08; B23C 2235/24

(57) ABSTRACT

A key-cutting machine includes: a support structure; a front operational area which is accessible by an operator; at least one milling and/or cutting unit which is positioned in the front operational area and which includes at least one end mill, and/or another cutting member, to carry out a bitting processing of a key. The key-cutting machine also includes at least one clamp, which is positioned in the front operational area, to hold the key to be machined, so that a face of the key to be engraved is arranged substantially horizontally. The key-cutting machine also includes a device for engraving at least one face of the head of said key, said device being positioned inside the front operational area of said duplicating machine; and at least one pair of engraving tools mounted on a support unit. Each engraving tool includes cutting sections for engraving a corresponding face of a key.

### CROSS-REFERENCE TO RELATED APPLICATIONS

The present application is a § 371 National Phase of PCT/IB2020/060204, filed Oct. 30, 2020, which claims priority of Italian Patent Application No. 102019000020208, filed Oct. 31, 2019, the entire contents of all of which are incorporated by reference herein as if fully set forth.

### FIELD OF THE INVENTION

The present invention relates to a device for engraving at least one face of a key, preferably the head of a key, as well as a key cutting machine with a device for engraving at least one face of a key, preferably the head of a key.

### BACKGROUND

Mechanical key cutting machines are known, which provide for the presence of a feeler which is made to slide on the profile of the original key to be duplicated, locked in a first clamp, and of a end mill, integral with the feeler, and acting on the key blank to be coded, locked in a second terminal, fixed with respect to the first.

Electronic duplicating machines are also known which use, instead of the feeler, an optical reader of the key bitting; in particular, the optical reader comprises a light source facing the original key and a sensor which collects the rays emitted by said source and passing through the coded portion of the key. These machines also require the presence of two clamps, one for the key blank to be coded, facing the end mill, and one for the original key to be duplicated, facing the optical reader. The two clamps are integral with each other and are movable with respect to the optical reader and the end mill, which are fixed with respect to the base of the machine.

Dedicated machines are also known which are configured exclusively to make an incision on one or both faces of the head of a key; in particular, these machines are used to engrave a code, logo or image on the head of the key and this may be required for various purposes, for example to identify the manufacturer of the key by its brand, or to supply a series useful information associated with the key and/or requested by the owner/manager of the key itself; for example, such information may relate to the access whose lock can be unlocked/locked by means of the key engraved in this way, or a serial code of the key itself, etc.

In the industrial field, for mass production, there are already known automated machines that carry out the operations of bitting the key and engraving its head in sequence. These machines, however, are particularly complex and bulky and, therefore, are not suitable for use in a professional or semi-professional context (i.e., in key duplication centers/shops).

Currently, therefore, for use in a professional or semi-professional environment, the operations of bitting the key and engraving its head are carried out in two distinct and independent machines. It is easy to understand how this is not completely satisfactory since the need to equip oneself with two distinct machines involves an increase in overall dimensions, requiring in particular to have suitable spaces available inside the duplicating center; furthermore, the use of two distinct machines makes the whole procedure more laborious and slow since, once the duplication process has been carried out in the first machine, the key must then be removed from the latter to be then inserted into the second machine in order to be able to carry out the engraving process (or vice versa).

Currently, again for use in the professional or semi-professional field, solutions are also known in which the operations of bitting the key and engraving its head are performed within the same machining area provided in the same machine. However, in known machines of this type, the intervention of the operator is always required to pass from one operation to another; in particular, in these machines, at the end of the bitting operation, the operator must move the key to a second clamp or remove the bitting end mill and install the end mill for engraving, enter new data and then start the operation of engraving.

DE10031713 describes a solution for making blanks or for duplicating keys in which a clamp is provided, which is movable in translation and in rotation, for the support of the key and a milling unit, with a single cutting element, which is mobile in translation (both vertically and horizontally) and in rotation.

U.S. Pat. No. 8,523,499 describes a device for brushing or crimping an article, such as an externally toothed wheel, used in wind turbines. In particular, the device comprises means for retaining and rotating the product and two milling units which are motorized independently or face opposite each other.

CH673612 describes a traditional key cutting machine with a single vertical end mill for the bitting processing of a key held by a corresponding clamp.

US2016/114412 describes a machine, suitable for industrial use, for the processing of keys in which a fixed milling unit is provided with three end mills, horizontally oriented, parallel and side by side, to machine a key that is mounted in a complex a frame configured to move said key.

CN204430389 discloses a key duplicating machine comprising a milling unit which is fixed and is provided with a circular end mill and a further milling unit which is stationary and is provided with an end mill; the machine also includes a clamp for holding the key to be machined and usable for both the two milling units.

### SUMMARY

The purpose of the invention is to propose a device for engraving a key, preferably for engraving the head of said key with a predefined code and/or image, which can be integrated into a duplicating machine configured to perform the encryption of the key.

Another object of the invention is to propose a device that allows both faces of the key head to be engraved quickly and efficiently.

Another object of the invention is to propose a device for engraving a key which is particularly compact.

Another object of the invention is to propose a device which allows to engrave a key in a safe and precise way.

Another object of the invention is to propose a device which allows to reduce energy consumption.

Another object of the invention is to propose a device which is simple and quick to maintain.

Another object of the invention is to propose a device which allows to engrave both faces of the head of the key and which is constructively and functionally simpler than currently known solutions.

Another object of the invention is to propose a device which can be obtained/manufactured in a simple, rapid and low-cost manner.

Another object of the invention is to propose a key duplicating machine which allows to perform key duplication and engraving operations quickly and easily.

Another object of the invention is to propose a duplicating machine which has particularly small dimensions.

Another object of the invention is to propose a duplicating machine which can be obtained simply, quickly and with low costs.

Another object of the invention is to propose a duplicating machine which is highly automated.

Another object of the invention is to propose a duplicating machine which is suitable for professional or semi-professional use.

Another object of the invention is to propose a device and a duplicating machine which are improvements and/or alternatives with respect to traditional solutions.

Another object of the invention is to propose a device and a duplicating machine which are suitable for use in a professional and/or semi-professional context.

Another object of the invention is to propose a key cutting machine which makes the entire key processing procedure particularly efficient, a procedure which includes both the cutting step on the key blank in order to reproduce on the stem, or on a portion of it, a given bitting profile, is the step of engraving a given code/image on one or both faces of the head of said key.

All these purposes, both individually and in any combination thereof, and others which will result from the following description, are achieved, according to the invention, with a device for engraving a face of a key, preferably the head of a key, as well as with a duplicating machine having the characteristics indicated in the appended claims.

### BRIEF DESCRIPTION OF THE DRAWINGS

The present invention is further clarified hereinafter in a preferred embodiment thereof, given purely by way of non-limiting example with reference to the appended drawings, in which:

FIG. 1 shows a perspective view of an electronic key cutting machine according to the invention during the cutting step of the blade of a key,

FIG. 1a shows an enlarged detail of FIG. 1,

FIG. 2 shows in front view a part of the front operating area of the machine of FIG. 1,

FIG. 3 shows according to a plan view the front operating area of the machine of FIG. 1,

FIG. 4 is a perspective view of the same electronic key cutting machine of FIG. 1 during the step of engraving the head of a key,

FIG. 4a shows an enlarged detail of FIG. 4,

FIG. 5 shows a front view of a part of the front operating area of the machine of FIG. 4,

FIG. 6 shows according to a plan view the front operating area of the machine of FIG. 4,

FIG. 7 shows in perspective view the duplicating machine of FIGS. 1 and 4 without the rear casing,

FIG. 8 shows a perspective view of the incision device according to the invention, without the front cover,

FIG. 9 shows a detail of the device of FIG. 8 in correspondence with the end mills,

FIG. 10 shows a detail of the device of FIG. 8 in correspondence with the end mills and without the external cover,

FIG. 11 shows in perspective view the engraving device with the upper end mill in action on the upper face of the key,

FIG. 12 shows in perspective view the engraving device with the end mill lower face in action on the lower face of the key,

FIG. 13 shows a face of the head of a key in which a code has been engraved by means of the device according to the invention.

### DETAILED DESCRIPTION OF THE PREFERRED EMBODIMENTS

Preliminarily, it should be noted that by “key” we mean a traditional type key, preferably metallic, comprising a head and a stem, on which the bitting is intended to be obtained. Preferably, the key has a laminar shape (i.e. one of the dimensions is much smaller than the other two) and, in particular, has two opposite faces substantially parallel to each other.

As can be seen from the figures, according to the invention, the electronic key cutting machine 1 comprises a support structure 10 and also comprises:
a front operational area 2 which is accessible by the operator and which is preferably removably covered and separated, at least partially, from the external environment 3 by means of a cover and/or protection casing (not shown) movable with respect to said support structure 10,
a rear containment area 5 which is covered and separated from the external environment by a casing 6 which is preferably fixed, i.e., not movable with respect to said support structure 10.

Conveniently, the duplicating machine 1 is of the professional or semi-professional type, that is, it is of the type generally present and used in centers/shops for key duplication. In particular, the duplicating machine 1 is of the type not used/usable in the industrial field and/or in series production.

Conveniently, the support structure 10 comprises at the bottom a support base 7 and also a dividing element 8, preferably defined by a substantially vertical dividing wall, which is mounted on said support base 7. In particular, the aforementioned two areas 2, 5 are defined above the support base 7 and are separated from each other by said dividing element 8.

Conveniently, the casing is associated with the support structure 10 so as to be able to be rotated or in any case moved with respect to the latter; suitably, moreover, the casing 6 is stably associated with the support structure 10 by means of suitable mechanical fixing means, for example by means of interlocking engagement and/or traditional fastening members (screws, rivets, bolts, etc.).

Conveniently, at least one end mill 11 (preferably but not necessarily a circular end mill), or other cutting member, of at least one milling and/or cutting unit 11′ (for flat keys and/or for laser keys) and at least one clamp 12 to hold a key, which can be a key blank to be machined or an already encrypted key to be duplicated and whose encryption you want to read/acquire, or an already encrypted key on which you then want to obtain an incision at one face of his head. Preferably, the milling and/or cutting unit 11′ is electrically isolated from the rest of the machine.

Advantageously, in the front operational area 2 are also provided means 14 for moving the clamp 12. Preferably, these moving means 14 comprise two carriages 15, 17 on which said at least one clamp 12 is mounted, to thus allow the movement of the key held by the corresponding clamp 12 both with respect to the end mill 11 and with respect to an engraving device 20, with which the machine 1 is provided, as well as to allow movement of the key held by the corresponding clamp 12 between the end mill 11 and the engraving device 20, and in particular between the area of action of the end mill 11 and the area of action of the engraving device 20.

Conveniently, the means for moving the clamp 12 are configured to move the clamp itself, and therefore a key held by said clamp, between a position closest to the drilling and/or cutting tool 11′ and a position closer to the engraving device 20.

Preferably, a first carriage 15 is provided which is motorized so as to allow the movement of said first carriage in both directions along a first horizontal axis X of the machine 1. Preferably, a second carriage 17 is mounted on the first carriage 15, which is also motorized so as to allow movement of the latter with respect to the first carriage 15 in both directions along the horizontal axis Y (which is perpendicular to the axis X) of the machine 1.

Advantageously, in an embodiment not shown, a further carriage (not shown) can be provided which is motorized so as to allow the handling of the clamp 12 and/or of the first carriage 15 and/or of the second carriage 17 along a third dimension Z, substantially vertical and perpendicular to the X and Y axes.

Conveniently, the clamp 12, which comprises a support, is mounted on the second carriage 17 and two jaws superimposed and mounted on a pin fixed to said support. Conveniently, the jaws have a square plan and the facing surfaces are differently shaped so as to be able to hold keys with different profiles together.

Conveniently, the clamp 12 is configured to retain the stem of the key 21 between its jaws and, in particular, to retain it at its lateral edge which is not intended to be coded (and which is generally substantially straight).

Advantageously, a knob 18 is associated with the upper portion of the pin of the clamp 12 and has the function of controlling the approach and removal of the two jaws and their locking to the support.

Conveniently, the carriages 15, 17 are driven and made to advance with respect to the end mill 11, within the area of action of the end mill 11 defined in the front operational area 2, so as to obtain in sequence the corresponding encryption slots on the stem of a key blank.

Conveniently, the rear containment area 5 is configured to house the components of the machine 1 for which direct access by the operator is not required during normal operation of the machine itself. In particular, in the rear containment area 5 are housed the motor (not shown) for driving the end mill 11 and the mechanical transmission members (not shown) for connecting the output of the motor to the end mill holder shaft; preferably, said end mill holder shaft is partially housed in the rear containment area 5 and protrudes into the front operational area 2.

Advantageously, the motors (not shown), preferably of the stepper type, for moving the first carriage 15 and the second carriage 17, are also housed in the rear containment area 5.

Advantageously, the machine 1 comprises a control and command unit 19 of the entire machine 1 and, in particular, said control and command unit controls the motorization of the displacement means 14 of the clamp 12 and/or the actuation of said end mill 11, and/or other cutting member.

Preferably, said control and command unit 19 is housed inside the rear containment area 5. Conveniently, said control and command unit 19 comprises an electronic card configured and programmed for the control and command of the various components of the machine 1.

Preferably, said unit 19 is electrically connected with the motors of the machine 1 and with a plurality of sensors installed on the machine itself in order to manage and monitor its operation. In particular, said unit 19 controls the motorization of the displacement means 14 of the clamp 12.

Preferably, said unit 19 also comprises memorization means.

Advantageously, said unit 19 can be connected to an external electronic device by means of one or more data communication interfaces 13 (for example, traditional ports for cables or connectors), or via wireless connections, to thus allow the machine 1 to exchange (in reception and/or transmission) of data, commands or information with the outside world.

Advantageously, the control unit 19 comprises and/or is associated with a user interface, for example a touch screen 23 and/or a control panel which allow the user to control the machine 1.

Advantageously, the machine 1 comprises a device 20 for making an incision 30 in correspondence of at least one of the two faces 31 of a key 21, preferably for engraving on the head 32 of a key a predefined code and/or a predefined image.

Conveniently, the engraving device 20 comprises at least one engraving tool which is actuated, in rotation and/or translation (for example by pressing it against the face of the key), so as to engrave at least one face 31 of the key.

Preferably, the engraving tool 20 comprises at least one end mill 22, or other tool with a rotating tip, which is driven in rotation around its longitudinal development axis.

Conveniently, in a version not shown here, the engraving tool can comprise an engraving tip which is pressed against the face of the key and which acts as a sliding engraver; in particular, the tip of this tool is pressed against the face of the key and is made to advance so as to rub/scratch said face and, therefore, the resulting incision 30 is defined by the smears/scratches obtained from said sliding contact.

Conveniently, the end mill 22 comprises a shank, for its assembly on a suitable mandrel 26, and a head in which the cutting portions of the end mill itself are formed.

Preferably, said end mill 22 has a particularly small diameter, for example from about 0.1 mm to about 1 mm (defined at its tip).

Conveniently, said end mill 22 with its mandrel 26 is mounted on a support unit 24, on which is also mounted a motor 27 configured to rotate said end mill 22 around its longitudinal axis, as well as the members of mechanical transmission 28 (for example of the transmission belts and of the return pulleys) to connect the output shaft of the motor 27 to said end mill 22.

Conveniently, the end mill 22 is mounted on a support unit 24 so that the rotation axis of the end mill itself is oriented substantially vertically (i.e., substantially along the direction of development of the Z axis), while the face 31 of the head of the key 21, held by the clamp 12, lies on a substantially horizontal plane (preferably defined by the X and Y axes).

Preferably, the incision device 20 can comprise a pair of end mills 22 and 22′, configured to act respectively on two mutually opposite faces 31 of the key 21, when it is held by the clamp 21. In particular, for this purpose, the cutting portions of the upper end mill 22 (and therefore intended to engrave the upper face of the key) are obtained in correspondence with its lower end, while the cutting portions of the lower end mill 22′ (and therefore intended to engrave the lower face of the key) are obtained at its upper end. Conveniently, both end mills 22 and 22′ have an axis of rotation which is oriented substantially vertically and, preferably, they are vertically facing and aligned with each other.

Conveniently, the two end mills 22 and 22′ are arranged so that the respective cutting portions are aligned and oriented vertically in opposite directions. Conveniently, the two end mills 22 and 22′ are not arranged side by side and parallel to each other.

Preferably, both end mills 22 and 22′ are mounted on the support unit 24 so that the respective axes of rotation of the end mills are oriented substantially vertically (i.e. along the direction of development of the axis Z); moreover, said rotation axes are also arranged substantially perpendicular to the faces (parallel to each other) of the head of the key 21, when the latter is held by the clamp 12; suitably, in this condition, the faces of the head of the key 21 lie on respective substantially horizontal planes (and preferably defined by the X and Y axes).

Conveniently, the two end mills 22 and 22′ can be mounted on the same support unit 24 which, in this case, preferably comprises a substantially C-shaped portion with the two parallel horizontal portions that each support one of the two end mills. Alternatively, in an embodiment not shown, the two end mills 22, 22′ can be mounted on two distinct elements of the same support unit 24.

Conveniently, the two end mills 22, 22′ are mounted on the support unit 24 so that the respective ends in which the cutting portions are defined are mutually spaced apart by a greater distance than the thickness of the head of the key 21 to be engraved.

Conveniently, both end mills 22 and 22′ are activated in rotation by the same and single motor 27 which, preferably, is mounted on the support unit 24. Alternatively, each end mill 22 and 22′ can be activated in rotation by a dedicated motor. Conveniently, mechanical transmission members 28 (preferably comprising pulleys and belts) are also provided inside the support unit 24 to transmit the rotation of the driving pulley, which is associated with the output of the motor 27, to the respective spindles 26 on which the end mills 22 and 22′ are mounted to cause the rotation of the latter around their respective longitudinal axes.

Preferably, the two end mills 22, 22′ are made to rotate around a vertical axis in opposite directions, however, they could also be driven in rotation in the same direction.

Advantageously, the engraving device 20 comprises movement means 25 configured to translate in a controlled manner the support unit 24, and consequently also the end mill(s) 22 and/or 22′, along a substantially vertical direction, i.e., along axis Z, in order to cause the cutting parts of the end mill 22 and/or 22′ to approach/move away from the face of the key 21 in which the incision 30 is intended to be made.

Advantageously, the movement means 25 they are also configured to translate in a controlled manner the support unit 24, and consequently also of the end mill(s) 22 and/or 22′, with respect to said key 21 along at least one horizontal direction (i.e. along the X axis and/or Y), preferably along a single horizontal direction (i.e. along the X axis), to cause the end mill 22 and/or 22′ to move towards/away from the clamp 12 which holds the key 21 in which it is intended to be made the incision 30.

Advantageously, the movement means 25 are configured to translate in a controlled way the support unit 24, and consequently also the end mill(s) 22 and/or 22′, both along a vertical direction (i.e., along the Z axis) and along two horizontal directions perpendicular to each other (i.e., along the X and Y axes).

Preferably, the movement means 25 comprise a first frame 40 which is motorized so as to allow the movement of said first frame in both directions along a first horizontal axis X or Y of the machine 1. In particular, a first frame 40 is associated with a first linear actuator 41 which causes the movement of said first frame 40 along a guide and/or support bracket 42. Conveniently, the first linear actuator 41 is mounted on said guide bracket and/or support 42.

Preferably, a second frame 43 is mounted on the first frame 40, which is also motorized so as to allow movement of the latter with respect to the first frame 40 in both directions along the vertical axis Z of the machine 1. In particular, a second linear actuator 44 is associated with the second frame 43 which causes the movement of said second frame 43 along a guide defined in said first frame 40. Conveniently, the second linear actuator 44 is mounted on the first frame 40.

Conveniently, the support unit 24 is mounted on the second frame 43 and, therefore, the movement of the first frame 40 causes the movement, along a horizontal axis X or Y, of the second frame 43 and of the support unit 24 with said at least one end mill 22 and/or 22′, while the movement of the second frame 43 causes the movement of the support unit 24 with said at least one end mill 22 and/or 22′ along the vertical axis Z.

Advantageously, the engraving device 20 is mounted on the dividing element 8 and, preferably, the movement means 25 comprise and/or are associated with an element, such as for example the guide and support bracket 42, which is mounted and fixed to the support structure 10 of the machine 1. Conveniently, said guide and/or support bracket 42 of said device 20 is fixed to the face of said partition element 8 facing towards the front operational area 2.

Preferably, the engraving device 20 is entirely housed inside the front operational area 2 of the machine.

Conveniently, said first 41 and/or said second linear actuator 44 is of the mechanical or electromechanical type and preferably comprises a stepping motor.

Conveniently, in the case of an engraving tool acting as a sliding engraver, a motor 27 is not provided for the rotation of the tool while the movement means 25 are configured to move the support unit 24 and the engraving tool along a vertical direction (i.e. along the Z axis) so as to press the tip of said engraving tool against the face of the key to be engraved, when it is held by the clamp 12. Furthermore, what is set forth herein and described in relation to the end mill(s) and end mills 22 and 22′ conveniently also applies—possibly with constructive adaptations that are widely within the reach of the skilled person—for engraving tools acting as sliding engravers.

Preferably, the incision device 20 also comprises a control unit (not shown) for the activation/deactivation of the rotation motor 27 of said at least one end mill 22 and of the actuators 41 and 44 of the movement means 25. In particular, this control unit of the device 20 is configured to command/control the power supply of said motor 27 for rotation of said at least one end mill 22 and of the actuators 41 and 44 of the movement means 25.

Conveniently, said control unit of the device 20 comprises a processor which, preferably but not necessarily, corresponds to the control and command unit 19 of the whole machine. Alternatively, the processor of the control unit of the device 20 can be implemented in an electronic board separate from the control and command unit 19 of the duplicating machine 1, although the two processors are suitably connected and communicating with each other.

Conveniently, the control unit of the device 20 is programmed to command and control the speed and/or direction of rotation of the drive motor or motors 27 of said at least one end mill 22 and/or 22′. Conveniently, the control unit of the device 20 is programmed to command and control the actuators 41 and 44 of the movement means 25 to thus cause the movement of said at least one end mill 22 and/or 22′ along at least two axes, preferably along the vertical axis Z or the horizontal axis X.

Conveniently, as said, the movement means 25 are configured to move the support unit 24, and therefore said at least one end mill 22 and/or 22′, with respect to the key 21 which is held by the same clamp 12 used to hold the key itself during processing, carried out by the end mill 11 of the cutting unit 11′, aimed at obtaining the bitting of the stem of said key.

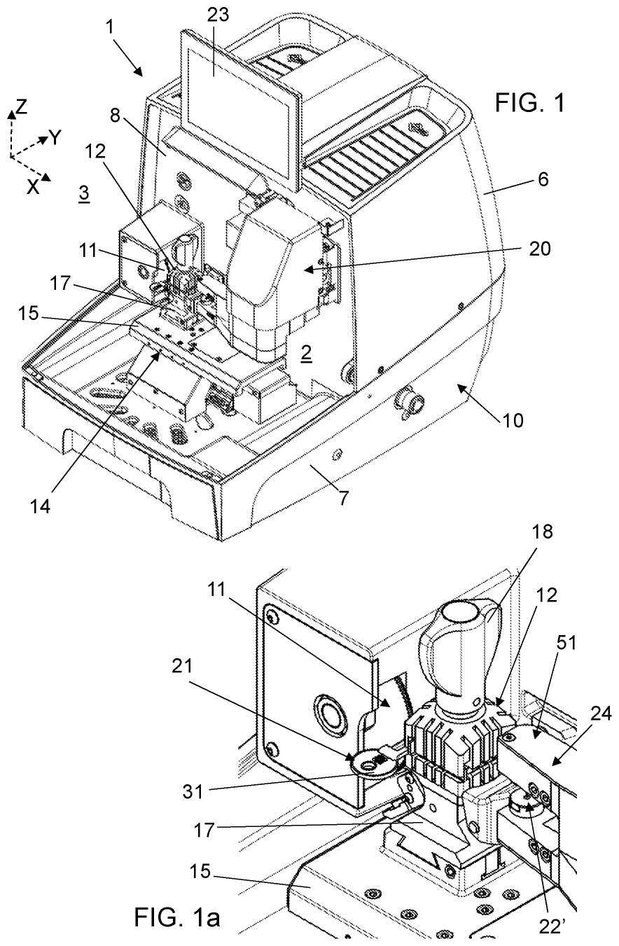

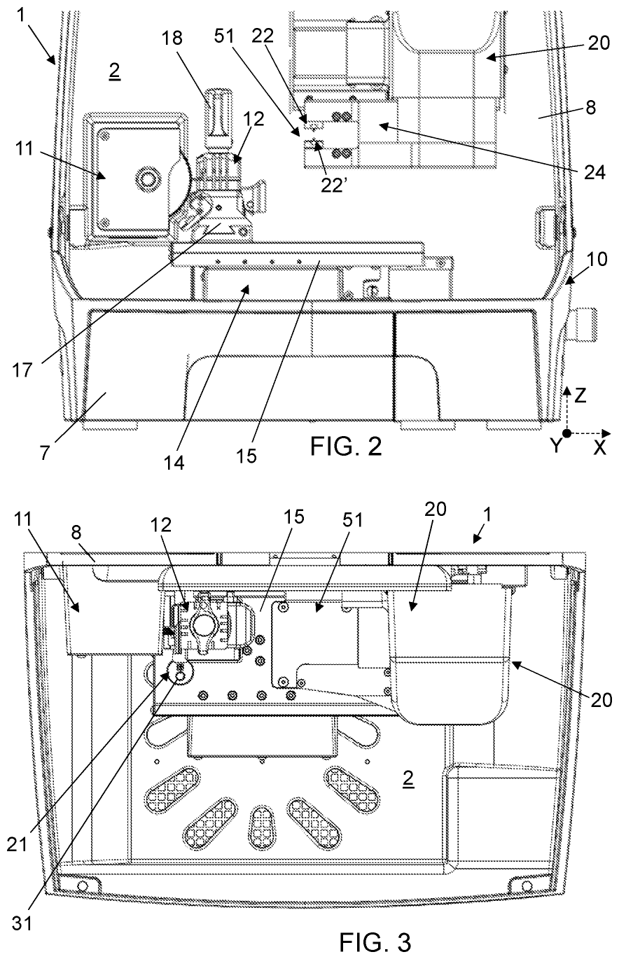

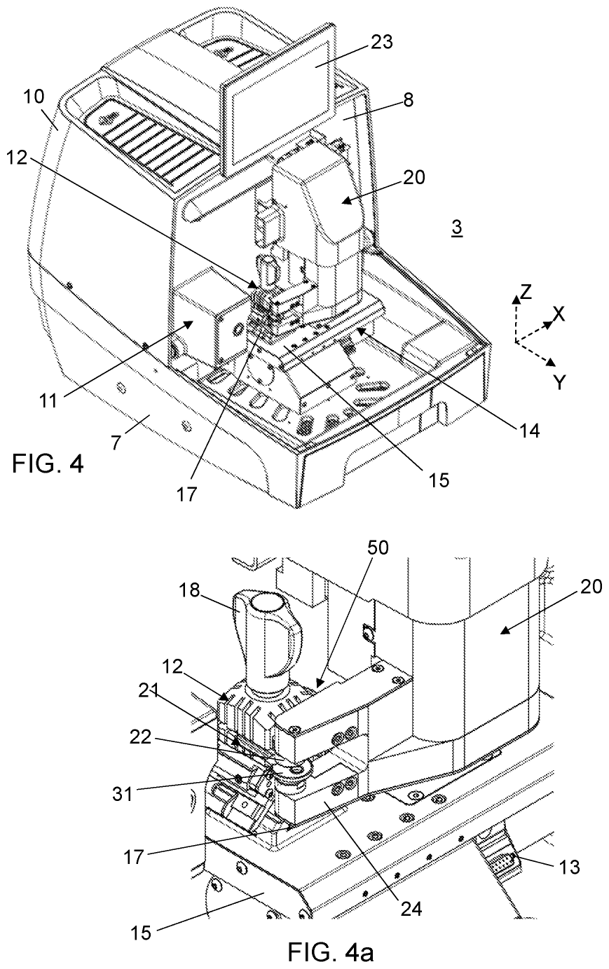

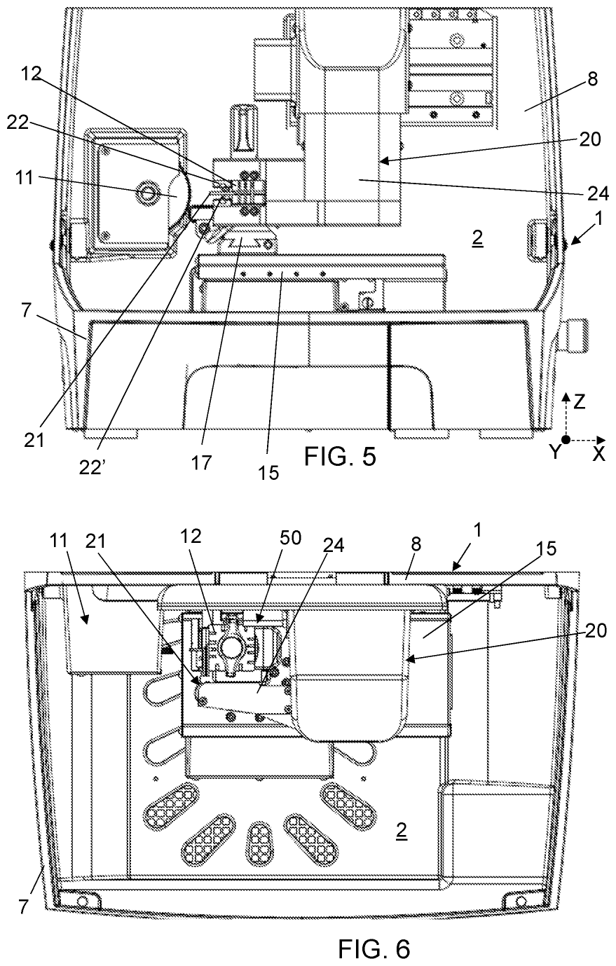

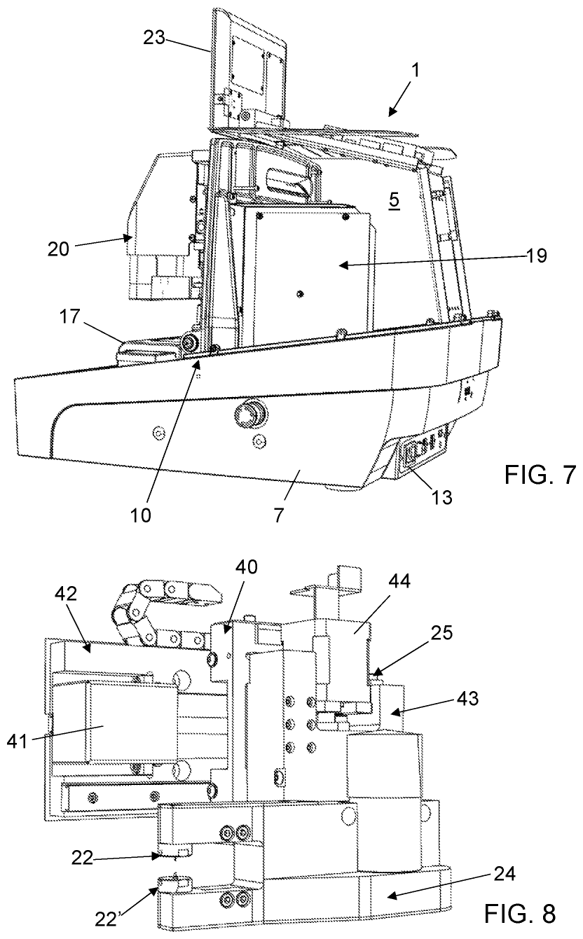

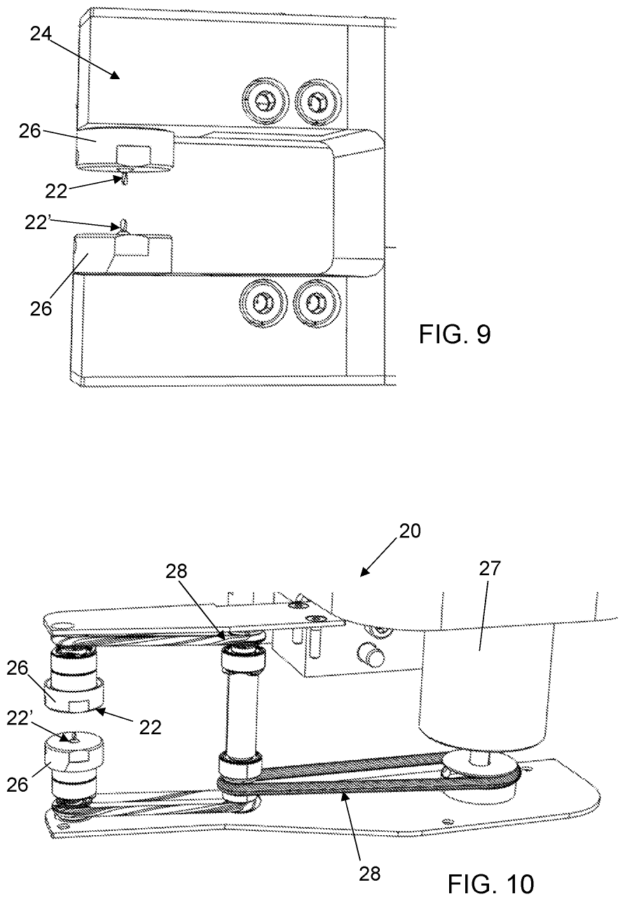

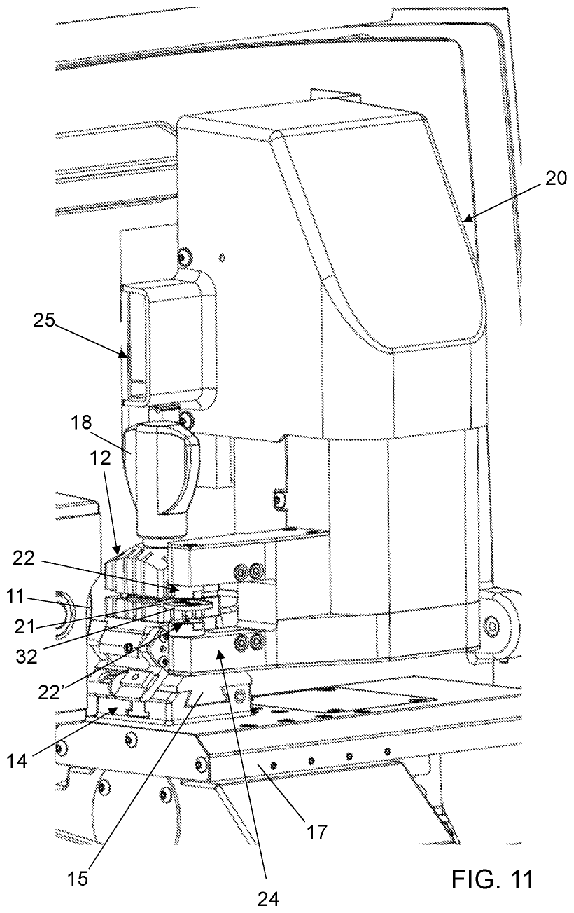

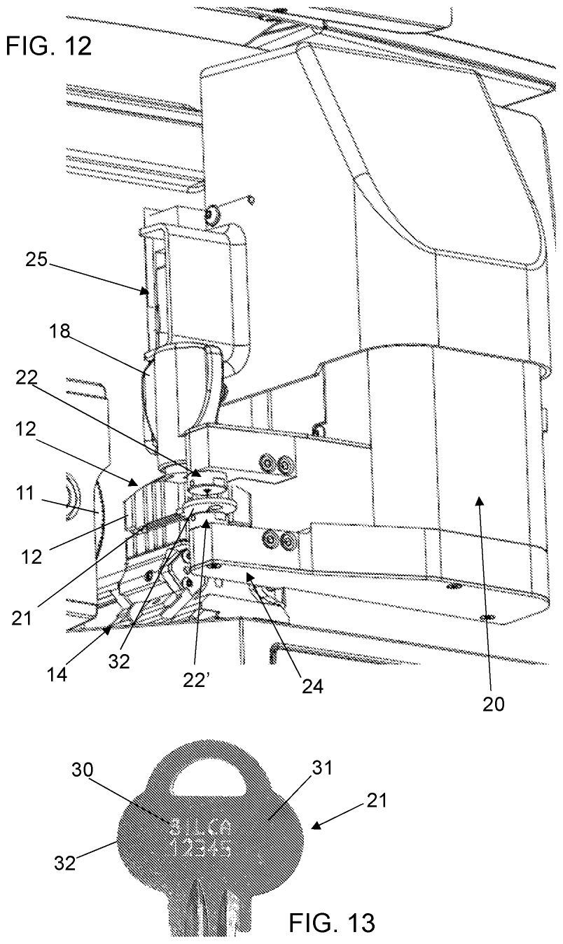

Advantageously, the movement means 25 are configured to move the support unit 24, and therefore said at least one end mill 22 and/or 22′, along at least one horizontal axis (i.e. along the X axis) between a work condition 50 (see FIGS. 4, 4a, 5 and 6), in which said at least one end mill 22 and/or 22′ is close to the clamp 12 and is substantially positioned above or below the upper face 31 and/or the face key 21 to be engraved, when it is clamped in clamp 12, and a rest condition 51 (see FIGS. 1, la, 2 and 3), in which said at least one end mill 22 and/or 22′ and the support units 24 are spaced from the clamp 12—and therefore from the key 21 held by the latter—in order not to clutter the removal and/or insertion of the key 21 inside the clamp itself.

In particular, in working condition 50, the end of the end mill 22 provided with the cutting portions is vertically facing the face 31 of the key 21 to be engraved.

Conveniently, the action of the moving means 14 of the clamp 12 and/or of the movement means 25 of said at least one end mill 22 and/or 22′ cause the relative movement along the three axes X, Y and Z of said end mill 22 and/or 22′ with respect to the key 21 held by the clamp. Preferably, while the end mill 22 and/or 22′ remains stationary (i.e. while the movement means 25 are deactivated), the moving means 14 of the clamp 12 cause the movement of the latter, and therefore of the key 21 held by the clamp, along the two horizontal axes X and Y, thus allowing to engrave on a portion of the head 32 of the key 21 a continuous groove defining a single alphanumeric character and/or an image of the code to be engraved on the head of the key. Preferably, while the clamp 12 and therefore the key 21 remain stationary (i.e. while their displacement means 14 are deactivated), the movement means 25 of said end mill 22 and/or 22′ cause the latter to be moved along the Z axis so as to interrupt the incision of the continuous groove defining a single alphanumeric character and/or image, to then pass to engrave a further groove—separate from the previous one—defining a further and distinct character and/or image of the code to be engrave on the head of the key.

Conveniently, the movement means 25 also cause the movement of said end mill 22 and/or 22′ along the Z axis so as to bring the respective face 31 of the key 21 into contact respectively with the upper end mill 22 or with the lower end mill 22′.

Conveniently, the processor of the control and command unit 19 of the machine 1 is electrically connected to the displacement means 14 of the clamp 12 to thus allow their control; the processor of the control unit of the engraving device 20 is electrically connected to the movement means 25 of said at least one end mill 22 and/or 22′, to thus allow their control; suitably, moreover, in this case, the two processors (i.e. that of the control and command unit 19 of the machine 1 and that of the engraving device 20) are electrically connected so as to communicate with each other and thus coordinate and synchronize the action of both said means for displacing 14 and movement 25. Alternatively, if the control and command unit 19 of the machine and the control unit of the device engraving 20 are implemented in a single processor, then the latter is electrically connected with both means of displacement 14 and movement 25 for their coordinated and synchronized control.

Alternatively, the moving means 14 of the clamp 12 and the movement means 25 of said at least one end mill 22 and/or 22′ can be activated simultaneously to cause the respective movement along the X and/or Y axis and this to in order to engrave on a face 31 of the key 21 a continuous groove defining a desired alphanumeric character and/or an image.

Conveniently, sensors (not shown) displacement means 14 of the clamp 12 are associated with the, which are electronically connected to the control and command unit 19 of the machine 1, to detect the position of the clamp and thus suitably control its movement along the X and/or Y axes.

Conveniently, sensors are associated with the movement means 25 of said at least one end mill 22 and/or 22′, which are electronically connected to the control unit of the device 20, to detect the position of said 22 and/or 22′ and thus suitably control its movement along the X and/or Y axes.

Conveniently, the movement means 25 of said at least one end mill 22 and/or 22′ are associated with traditional limit switch devices.

Conveniently, the engraving device 20 is electrically isolated from the rest of the machine 1 and, in particular, from the support structure 10. Advantageously, the entire engraving device 20 is electrically isolated from the dividing element 8 on which it is mounted, preferably by means of a sheet of polyethylene terephthalate (also known by the trade name “mylar”) which is interposed between the back of the bracket 42 and the front face of the dividing element 8.

Advantageously, said engraving device 20 also comprises means for detecting when the free end (provided with the cutting portions) of said at least one end mill 22 and/or 22′ comes into contact with the face 31 of the key 21 to be engraved. In particular, for this purpose, at least one end mill 22 and/or 22′- and preferably both—is associated with an electrical contact (not shown) configured in such a way that, when the tip of the end mill comes into contact with the key 21 held by clamp 12, the closure of an electric circuit occurs and, suitably, this is detected/communicated to the control unit 20 of the device 20 to thus correspondingly control the movement means 25 of said at least one end mill 22 along the′ vertical axis Z.

Suitably, therefore, the movement means 25 are configured to move vertically along the Z axis of said at least one end mill 22 and/or 22′ until the electrical contact present in correspondence with the end mill of the tip comes into contact with the face 31 of the key 21, thus closing the electrical circuit, or possibly this translation can continue for a certain time interval after the closure of el electrical circuit.

The operation of the engraving device 20, according to the invention, and of the duplicating machine 1 incorporating said device, is clear from what has just been described.

First, the operator accesses the front operational area 2 of the machine 1 in order to position the key blank 21 to be coded and engraved in correspondence with the clamp 12.

Once this has been done, the operator can set and control, by acting on traditional means of input (buttons or touch-screen 23) of which the machine 1 is provided, the cutting operation of the key 21 blocked on the clamp 12 so as to replicate on the stem of this, by means of the end mill 11 (or other cutting device) provided in the front operational area 2 of the machine, a specific bitting profile.

Conveniently, before, during or—preferably—after having carried out the coding process carried out by means of the end mill 11 of the cutting unit 11′, the operator can set and command the activation of the engraving device 20 in order to engrave a code and/or predefined image on one or both faces 31 of the key 21 held by said clamp 12.

In particular, the operator can set and control, by acting on traditional input means (buttons or touch-screen 23) of which the machine 1 is provided with the codes and/or images (or other signs in general) to be engraved on the face 31 or on the faces of the key 21. For this purpose, the control and/or command unit of the machine or the control units of the device 20 are configured to obtain, on the basis of the codes and/or images to be engraved, the corresponding instructions to be provided to the moving means 14 of the clamp and/or to the movement means 25 of said at least one end mill.

Conveniently, the codes and/or images to be engraved can be the same on both faces 31 of the key or they can be different.

Then, once the engraving device 20 has been activated, the control unit of the device activates the movement means 25 so as to translate the end mill 22 horizontally and thus bring it into working condition 50, i.e. in a condition in which the end mill 22 is vertically aligned with one of the faces 31 of the head of the key 21 to be engraved. Conveniently, in this phase, also the displacement means 14 of the clamp 12 could be operated in such a way as to make the clamp 12, and therefore the key 21 held by it move horizontally, in order to bring it closer to the end mill 22, the engraving device 20.

Subsequently, the means 25 for moving said at least one end mill 22 cause the latter to be translated along a vertical direction (i.e. along the Z axis) until the cutting portions (defined at the tip) of the end mill 22 are brought into contact with the face 31 of the key 21 to be engraved.

Advantageously, when the end mill 22 encounters the face 31 of the key 21 closes the electric circuit and the occurrence of such a condition is detected by the control device 20.

Subsequently, then, activates the rotation motor 27 of tool 22.

Suitably, the moving means 14 of the clamp 12 and/or the movement means 25 of said at least one end mill 22 cause the relative movement of the head 32 of the key 21 with respect to said end mill, activated in rotation, so as to obtain one or more continuous grooves, each of which defines an alphanumeric character of a code or image to be engraved on the face of the key.

Advantageously, if the key 21 is to be engraved on both faces 31 of its head 32, the above operation can then be repeated with the other end mill of the device 20 at the other face of the key.

Once the incision has been completed, the movement means 25 move said at least one end mill 22 away from the key 21, to thus allow the operator to take the coded key 21 from the clamp 12 at its stem and engraved at its head.

Conveniently, the incision device 20 according to the invention has been described mainly in its application aimed at making an incision 30 in correspondence of one or both faces 31 of the head 32 of a key, however it is understood that said device can also be used to make one or more incisions in correspondence with the face of the stem, incisions that for example define the key bitting in the case of “laser” or “trace” keys, that is, those keys in which the key, both internal and external, is pinned performed by obtaining/engraving, using an end mill, a slot and/or groove on one or both faces of the key blade.

From what has been said it is clear that the device, according to the invention, for engraving at least one face of a key is particularly advantageous in that:
it makes the key cutting machine in which it is incorporated more convenient, efficient and highly automated; in particular, it allows to have a machine in which a single processing flow of a key is implemented since, first, the coding processing of the blade of a key is carried out and, subsequently, automatically and without interruptions, the processing of engraving of a code and/or image on the head of the key itself,
it is compact and economical,
it allows to engrave both faces of the key head in a particularly precise way.

1. A key-cutting machine (1) comprising:
a support structure (10),
a front operational area (2) which is accessible by an operator,
at least one milling and/or cutting unit (11′) which is positioned in said front operational area (2) and which comprises at least one end mill (11), and/or another cutting member, to carry out a bitting processing of a key (21),
at least one clamp (12), which is positioned in said front operational area (2), to hold said key (21) to be machined, so that a face (31) of the key (21) to be engraved is arranged substantially horizontally,
a device (20) for engraving at least one face (31) of the head (32) of said key (21), said device being positioned inside the front operational area (2) of said duplicating machine (1),
at least one pair of engraving tools (22, 22′) which are mounted on a support unit (24), each engraving tool (22, 22′) is provided, at a free end thereof, with cutting sections for engraving a corresponding face (31) of a key (21), each engraving tool (22, 22′) of said pair is configured to act on one of the two opposite faces (31) of the key (21), the free ends of said at least one pair of engraving tools (22, 22′) being mutually facing and spaced apart and/or distancing by a greater distance than the thickness that the key (21) to be engraved has in correspondence with one of its areas, corresponding to the head of said key, to be engraved by said tools, the free ends of said engraving tools (22, 22′) being vertically aligned and facing each other, said two engraving tools (22, 22′) of said at least one pair being operated by a same motor (27) mounted on said support unit (24),
movement means (25) configured to translate in a controlled manner said support unit (24) and at least one pair of engraving tools (22, 22′) along a substantially vertical axis (Z), to thereby bring into contact/move away the cutting sections of each engraving tool (22, 22′) of said pair with/from said face (31), to be engraved, of the key (21) when it is held by said clamp (12), and along at least one horizontal axis (X, Y), to bring said engraving tools (22, 22′) closer to/away from said clamp (12) configured to hold said key (21), and
a control unit for controlling said movement means (25).

2. The key-cutting machine according to claim 1, further comprising a support element (42) of said movement means (25), said support element (42) being configured to be fixed to the support structure (10) of said key cutting machine (1).

3. The key-cutting machine according to claim 2, wherein said support element (42) is configured to be fixed to a dividing element (8) which, inside said machine (1), separates said front operational area (2) from a rear area (5).

4. The key-cutting machine according to claim 1, wherein said control unit is configured to control the activation/deactivation of said motor (27) for driving said two engraving tools (22, 22′) of said at least a pair of engraving tools (22, 22′).

5. The key-cutting machine according to claim 1, wherein:
said engraving tool comprises at least one end mill (22, 22′), or another tool with a rotating tip,
said motor (27) is configured to rotate said at least one end mill (22, 22′), or other rotating tip tool, around its longitudinal development axis which is oriented substantially vertically (Z).

6. The key-cutting machine according to claim 1, wherein said support unit (24) comprises a substantially “C”-shaped portion with the two parallel horizontal sections that each support one of said engraving tools (22, 22′) of said couple.

7. The key-cutting machine according to claim 1, wherein said two engraving tools (22, 22′) of said pair are driven in rotation by the same motor (27), according to opposite rotation directions.

8. The key-cutting machine according to claim 1, wherein said movement means (25) comprise:
a first frame (40) which is motorized so as to allow movement of said first frame in both directions along a first horizontal axis (X, Y) of the machine (1),
a second frame (43) which is mounted on the first frame (40) and which is motorized so as to allow movement of said second frame (43) with respect to the first frame (41) in both directions along the vertical axis (Z) of the machine (1), said support unit (24) and said at least one engraving tool (22, 22′) being also mounted on the second frame.

9. The key-cutting machine according to claim 1, further comprising means for detecting when the free end, provided with the cutting portions, of said at least one engraving tool (22, 22′) comes into contact with the face (31) of the key (21) to be engraved, said detection means being connected to the control unit for correspondingly controlling the translation caused by said movement means (25) of said at least one engraving tool (22) along a vertical axis (Z).

10. (canceled)

11. A key-cutting machine (1), comprising:
a support structure (10),
a front operational area (2) which is accessible by an operator,
at least one milling and/or cutting unit (11′) which is positioned in said front operational area (2) and which comprises at least one end mill (11), and/or another cutting member, to carry out the bitting processing of a key (21),
a device (20) for engraving at least one face (31) of a head (32) of a key (21), said device (20) being positioned inside said front operational area (2) provided with at least a milling and/or cutting unit (11),
at least one clamp (12) which is configured to hold the same key (21) both during a bitting process carried out by means of said end mill (11), and/or another cutting member, and during an engraving process carried out by means of said device (20),
displacement means (14) of said clamp (12) along two horizontal axes (X, Y) perpendicular to each other of said machine (1), said displacement means (14) of said clamp (12) being configured to move the same key (21), held by said clamp (12), between a position closest to said at least one milling and/or cutting unit (11′) and a position closest to said device (20) to engrave at least one face (31) of the key,
said device (20) comprises:
at least one engraving tool (22, 22′) which is mounted on a support unit (24) and which is provided, at its free end, with cutting sections to engrave at least one face (31) of a key (21),
movement means (25) configured to translate in a controlled manner said support unit (24) and said at least one engraving tool (22, 22′) along a substantially vertical axis (Z), to thereby bring into contact/move the portions away of cutting of said engraving tool (22, 22′) to/from said face (31), to be engraved, of the key (21) when held by said clamp (12), and along at least one horizontal axis (X, Y), to bring said engraving tool (22, 22′) closer to/away from said clamp (12) configured to hold said key (21), and
a control unit for controlling said movement means (25).

12. The key-cutting machine according to claim 11, wherein:
said at least one engraving tool comprises at least one end mill (22, 22′), or another tool with a rotating tip,
said at least one engraving tool further comprises at least one motor (27) to rotate said at least one end mill (22, 22′), or other rotary tip tool, around a longitudinal development axis which is oriented substantially vertically (Z), and
said control unit is configured to control activation/deactivation of said motor (27).

13. The key-cutting machine according to claim 11, wherein said displacement means (14) of said clamp (12) comprise:
a first carriage (15) which is motorized so as to allow movement of said first carriage in both directions along a first horizontal axis X of the machine (1),
a second carriage (17) which is mounted on the first carriage (15) and which is also motorized so as to allow movement of said second carriage (17) with respect to the first carriage (15) in both directions along the horizontal axis Y (which is perpendicular to the X axis) of the machine (1).

14. The key-cutting machine according to claim 11, wherein the movement means (25) are configured for moving the support unit (24), and then said at least one engraving tool mounted on said unit, along at least a horizontal axis between a working condition (50), in which said at least one engraving tool (22, 22′) is proximate the clamp (12) and is substantially positioned above or below the upper face (31) and/or the lower face of the key (21) to be engraved, when the key (21) is clamped in the clamp (12), and a rest condition (51), in which said at least one engraving tool (22, 22′) and the support unit (24) are spaced from the clamp (12)—and therefore from the key (21) held by the clamp (12)—so as not to clutter the removal and/or insertion of the key (21) inside the clamp itself.

15. The key-cutting machine according to claim 11, further comprising a control and command unit (19) which controls motorization of the displacement means (14) of the clamp (12) and/or the actuation of said end mill (11), and/or another cutting member.

16.-17. (canceled)

18. The key-cutting machine according to claim 11, further comprising a rear containment area (5) which is separated and divided from the front operational area (2) by a dividing element (8), said incision device (20) being mounted on said dividing element (8) and being entirely housed inside the front operational area (2) of said machine.

19.-20. (canceled)

21. The key-cutting machine according to claim 11, wherein the movement means (25) of said incision device (20) are configured for moving the support unit (24), and then said at least one engraving tool (22, 22′), with respect to the key (21) which is held by the same clamp (12) used to hold the key itself during processing, carried out by the end mill (11) and/or by another cutting member, finalized to obtain encryption on said key.

22. The key-cutting machine according to claim 11, further comprising means for moving said clamp (12) along two horizontal axes (X, Y) perpendicular to each other of said machine (1), said movement means (14) of said clamp (12) being controlled in such a way as to move the key (21), held by said clamp (12), both with respect to the end mill (11) and/or said other cutting member in order realize on said key (21) a given bitting, and with respect to said at least one engraving tool (22, 22′) of said device (20) in order to make a given engraving on one face (31) of said key (21).

23. The key-cutting machine according to claim 11, further comprising a control unit which is configured to control said displacement means (14) of said clamp (12) so as to perform sequentially, completely automated, the following operations:
move the key (21), held by said clamp (12), with respect to the end mill (11), and/or to said other cutting member, in order to create a specific cut on said key (21),
move the key (21), still held by the same clamp (12), near the area of action of said cutting device (20),
move the key (21), still held by the same clamp (12), with respect to the engraving tool (22, 22′) of said engraving device (20) in order to make a specific engraving on at least one face (31) of said key (21).

24. The key-cutting machine according to claim 11, further comprising a control unit which is configured to control said means for moving said clamp (12) so as to perform sequentially, preferably completely automated, the following operations:
to move the key (21), held by the clamp (12), with respect to the engraving tool (22, 22′) of said engraving device (20) in order to make a specific incision on at least one face (31) of said key (21).
move the key (21), still held by the same clamp (12), near the action area of the end mill (11), and/or of said other cutting member,
moving the key (21), held by said clamp (12), with respect to the end mill (11), and/or to said other cutting member, in order to create a specific bitting on said key (21).

25. The key-cutting machine according to claim 11, wherein the key-cutting machine is configured so that, in use, the displacement means (14) of said clamp (12) which holds the key (21) to be engraved and the movement means (25) of said at least one engraving tool (22, 22′) of said engraving device (20) are controlled and synchronized with each other so that said at least one engraving tool (22, 22′) affects a corresponding face of said key (21) at least two grooves, mutually separated, each of which defines an alphanumeric character, a symbol, and/or an image.
